(19) United States
(12) Patent Application Publication
(10) Pub. No.: US 2023/0311295 A1
(43) Pub. Date: Oct. 5, 2023

(54) MITER SAW STAND AND METHOD OF MOUNTING A MITER SAW TO A MITER SAW STAND

(71) Applicant: Perfect Site LLC, Las Vegas, NV (US)

(72) Inventor: Jared W. Hanlon, Las Vegas, NV (US)

(21) Appl. No.: 18/127,851

(22) Filed: Mar. 29, 2023

Related U.S. Application Data
(60) Provisional application No. 63/326,263, filed on Mar. 31, 2022.

(51) Int. Cl. B25H 1/00; B23D 47/02

(52) U.S. Cl. CPC B25H 1/0042; B23D 47/02

(57) ABSTRACT

A miter saw stand is provided. The miter saw stand is structured to be coupled to a miter saw. The miter saw has a plurality of mounting holes and includes a plurality of spaced apart legs each coupled to one another and together configured to support the miter saw. Each leg may have a first end, a second end located opposite the first end, and an interconnect apparatus coupled to the second end and configured to extend into a corresponding one of the mounting holes of the miter saw in order to mount the leg to the miter saw. The miter saw is configured to be supported in an elevated position at the second ends of the plurality of legs of the miter saw stand.

### RELATED APPLICATION DATA

The present application claims priority to U.S. Application Ser. No. 63/326,263, filed Mar. 31, 2022, which application is incorporated in its entirety herein by reference.

### FIELD OF THE INVENTION

The present invention relates to miter saw stands. The present invention also relates to methods of mounting a miter saw to a miter saw stand.

### BACKGROUND OF THE INVENTION

Miter saw stands and methods of mounting miter saws to miter saw stands are known. However, known miter saw stands are often not securely mounted to miter saws, thus causing injury to operators. An improved miter saw stand and associated method of mounting is thus desirable.

### SUMMARY OF THE INVENTION

One aspect of the invention provides for a miter saw stand. The miter saw stand is structured to be coupled to a miter saw. The miter saw has a plurality of mounting holes and includes a plurality of spaced apart legs each coupled to one another and together configured to support the miter saw. Each leg may have a first end, a second end located opposite the first end, and an interconnect apparatus coupled to the second end and configured to extend into a corresponding one of the mounting holes of the miter saw in order to mount the leg to the miter saw. The miter saw is configured to be supported in an elevated position at the second ends of the plurality of legs of the miter saw stand.

Another aspect of the invention calls for a method of mounting a miter saw to a miter saw stand. The miter saw has a plurality of mounting holes. The method comprises providing the miter saw stand with a plurality of spaced apart legs each coupled to one another, each leg of the plurality of legs comprising a first end, a second end disposed opposite the first end, and an interconnect apparatus coupled to the second end; and extending the interconnect apparatus into a corresponding one of the mounting holes of the miter saw to mount the leg to the miter saw.

Further objects, features, and advantages of the present invention over the prior art will become apparent from the detailed description of the drawings which follows, when considered with the attached figures.

### DESCRIPTION OF THE DRAWINGS

FIG. 1 is an isometric view of a miter saw stand, shown with a miter saw in phantom line drawing, and shown in a DEPLOYED position, in accordance with one non-limiting embodiment of the disclosed concept;

FIG. 2 is an exploded isometric view of the miter saw stand of FIG. 1;

FIG. 3 is an enlarged view of a portion of the miter saw stand of FIG. 1, shown with a portion cutaway for ease of illustration;

FIGS. 4 and 5 show different exploded isometric views of portions of another miter saw stand, in accordance with another non-limiting embodiment of the disclosed concept; and

FIG. 6 is another view of the miter saw stand of FIG. 1, shown in a COLLAPSED position.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

As employed herein, the term “coupled” shall mean connected together either directly or via one or more intermediate parts or components.

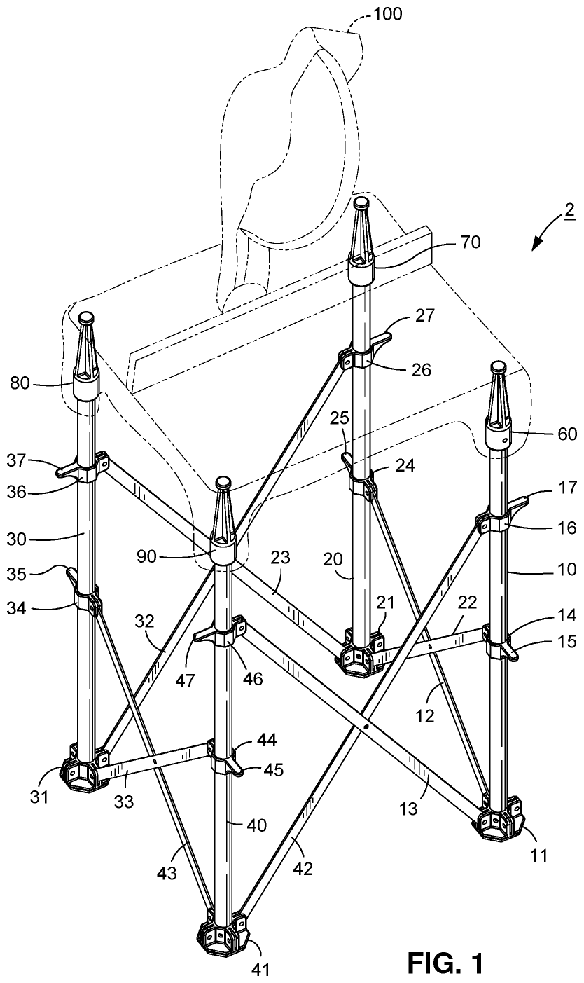

One embodiment of the invention is a stand, and preferably a tool stand (e.g., without limitation, miter saw stand 2), such as for supporting one or more tools in an elevated position for use. The stand 2 is shown in FIG. 1 in a DEPLOYED position, and is shown as employed with a miter saw 100 in phantom line drawing. While stand 2 is being shown as employed with a miter saw 100, it will be appreciated that stand 2 may be used in suitable alternative applications (including for use in supporting other types of tools whether powered or unpowered, or other elements), without departing from the scope of the disclosed concept.

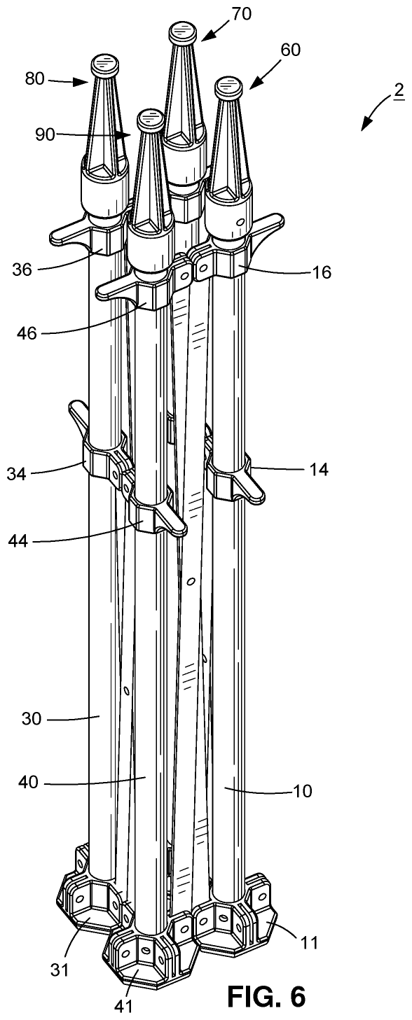

In one embodiment, the stand 2 is configured to be collapsible (e.g. thus movable between a first or deployed position (such as for supporting a miter saw) and a second or collapsed position (such as for storage), wherein in a preferred configuration, the size of the stand 2 is reduced in its second or collapsed position as compared to its first or deployed position). See FIG. 6, for example, which shows miter saw 2 in a COLLAPSED position.

Collapsibility may be achieved by virtue of stand 2 having a plurality of legs 10,20,30,40, where a position of the legs 10,20,30,40 may be changed relative to one another, and particularly where a distance between the legs may be changed. In one configuration, each of the legs 10,20,30,40 (such as a first or bottom end thereof) is preferably coupled to a base member 11,21,31,41 (or foot, etc.) in order to stably position miter saw stand 2 on the ground during use.

Accordingly, the legs 10,20,30,40 are each spaced a distance from one another and are configured to move between the DEPLOYED and COLLAPSED positions such that as the legs 10,20,30,40 move from the DEPLOYED position toward the COLLAPSED position, the distance decreases. In other words, the legs 10,20,30,40 move closer to one another when the miter saw stand 2 is collapsed.

The means for adjustably positioning the legs 10,20,30,40 preferably comprises a plurality of brace members 12,13,22,23,32,33,42,43 which are movably connected to the legs 10,20,30,40. Each of the brace members 12,13,22,23,32,33,42,43, may each be rotatably coupled at a first end to one of the base members 11,21,31,41 (such as by coupling an end thereof to a flange of the base member 11,21,31,41, such as via a pin). Further, each of the brace members 12,13,22,23,32,33,42,43 may be movably connected at their opposing or second ends to a slider member 14,16,24,26,34,36,44,46, which slider member is movably/slidably mounted to a corresponding leg 10,20,30,40. As illustrated, pairs of brace members (e.g. braces 13,42) may be rotatably joined to one another and the ends of the braces of each pair of braces may be movably coupled to two of the legs (e.g. 10,40) in a manner which allows each pair of brace members to be moved between a position in which the two brace members extend generally parallel to one another (corresponding to the COLLAPSED position of the stand, as in FIG. 6) and a position in which they extend generally perpendicular to one another (corresponding to the DEPLOYED position of the stand, as in FIG. 1).

Slider members 14,16,24,26,34,36,44,46 may each have a corresponding lever portion 15,17,25,27,35,37,45,47 that aides users in moving them up and down in order to move miter saw 2 between DEPLOYED (FIG. 1) and COLLAPSED (FIG. 6) positions, and also to adjust height in a DEPLOYED position.

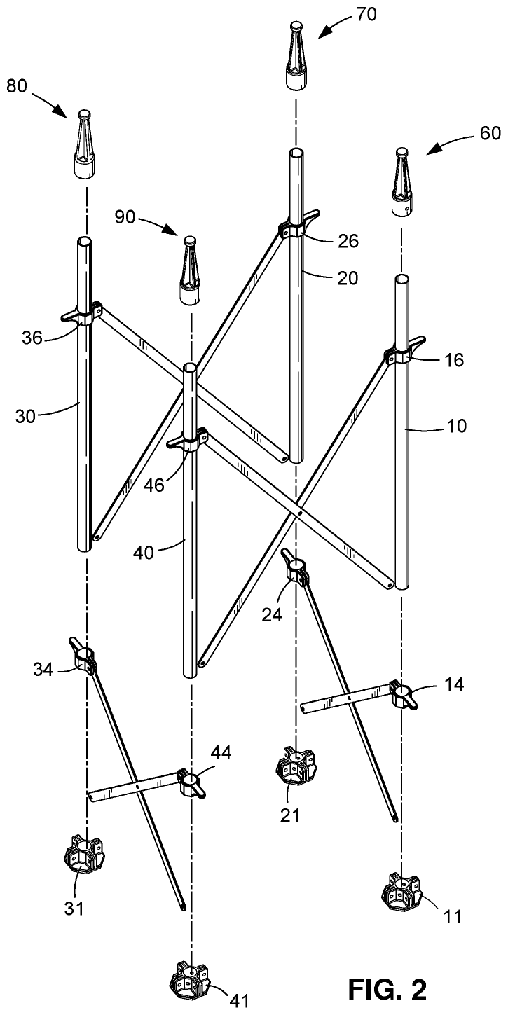

Located opposite base members 11,21,31,41 (such as at a top or second end of the legs 10,20,30,40) are a corresponding plurality of interconnect apparatus 60,70,80,90. In one example, the interconnect apparatus 60,70,80,90 are each unitary components made from single pieces of material. In general, the interconnect apparatus 60,70,80,90 are configured to facilitate connection of a tool, such as a miter saw 100, to the stand 2. See also FIG. 2, from which it can be appreciated that interconnect apparatus 60,70,80,90, are each coupled to a corresponding one of legs 10,20,30,40 and configured to be coupled to miter saw 100 (FIG. 1).

In one embodiment, the stand 2 includes one or more interconnect apparatus, such as for associating one or more tools with the stand 2, and particularly the legs 10,20,30,40. In general, the interconnect apparatus are configured to allow a tool, such as a miter saw, to be supported at the tops of the legs 10,20,30,40 without the use of a planar support or work surface being the support for the tool. In one configuration, the stand 2 is configured to extend into a plurality of mounting holes or apertures of a tool, such as the base or feet of a miter saw 100. In the example of FIG. 1, the stand 2 extends into four mounting holes of the miter saw 100, e.g., each of the four interconnect apparatus 60,70,80,90 extends into a corresponding one of the four holes of the miter saw 100.

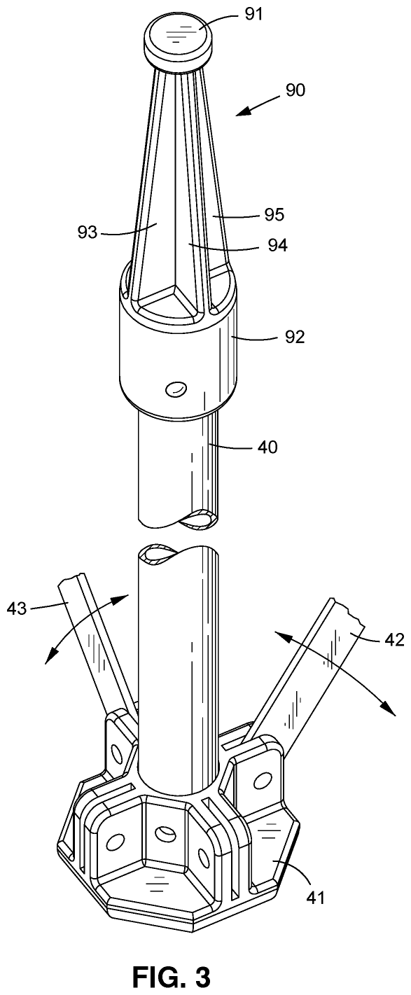

Referring to FIG. 3, in one embodiment, the interconnect apparatus 90 may be generally conical in shape, such as by having a disc-shaped stud portion 91, a base portion 92 located opposite stud portion 91, and a plurality of body portions (e.g., triangular-shaped body portions or flanges 93,94,95 (in FIG. 3, only 3 of 4 of the portions/flanges are visible) extending therebetween. In operation, each leg (e.g. leg 40 in FIG. 3) is configured to extend into and couple with base portion 92, either via a press-fit or snap-fit mechanism, a threadable connection, and/or via one or more intermediate components. In one embodiment, each of the base portions (e.g., base portion 92) are coupled to the second end of the corresponding legs 10,20,30,40 such that the body portions 93,94,95 are configured to engage the miter saw 100 in a press-fit manner.

Moreover, it will be appreciated that stud portion 91 is advantageously configured to aide users during assembly without posing a risk of injury, such as might occur if this region of an interconnect apparatus were relatively sharp. Accordingly, in addition to being disc-shaped, a suitable alternative stud-portion could have other shapes (e.g., be spherical), without departing from the scope of the disclosed concept. Body portions 93,94,95, in addition to being shaped in a manner that is conducive for molding, also provide an improved mechanism by which stand 2 can be connected to miter saw 100, namely providing a relatively narrow, tapered surface which presents a low-friction guiding surface for an object (such as a miter saw stand) to be placed thereon and moved downwardly).

Further, in this configuration, interconnect apparatus 90 is configured to extend into and engage with an opening in miter saw 100 (FIG. 1) (such as in the base or feet of such a saw). Rather than having the miter saw 100 be flush with and substantially engage over a relatively large surface area of the stand 2, the miter saw 100 is configured to cut into (press/engage) the interconnect apparatus 90 (and the other interconnect apparatus 60,70,80) and create a relatively large pressure therebetween. That is, an edge of the miter saw 100 proximate an opening is configured to dig into each of body portions 93,94,95 (and a fourth body portion, not shown in the illustrated example) along localized regions, thus resulting in a high degree of pressure connecting the two components (e.g., pressure equals force divided by surface area). It will also be appreciated that from top to bottom, a wall thickness of body portions 93,94,95 is preferably consistent. Furthermore, while ideally the horizontal surfaces of miter saw 100 are flat when in use, this is hardly the case. By having the high/pressure and friction fit engagements, miter saw stand 2 can advantageously be adjustable to a degree when it is connected to miter saw 100. For example, different body portions can slide with respect to miter saw 100 until optimal coupling and friction/fit engagement is achieved.

Accordingly, each of the legs 10,20,30,40 may include a first end, a second end located opposite the first end, and the interconnect apparatus 60,70,80,90 coupled to the second end and configured to extend into a corresponding one of the mounting holes of the miter saw 100 in order to mount the legs 10,20,30,40 to the miter saw 100. The miter saw 100 may be configured to be supported in an elevated position at the second ends of the plurality of legs 10,20,30,40 of the miter saw stand 2.

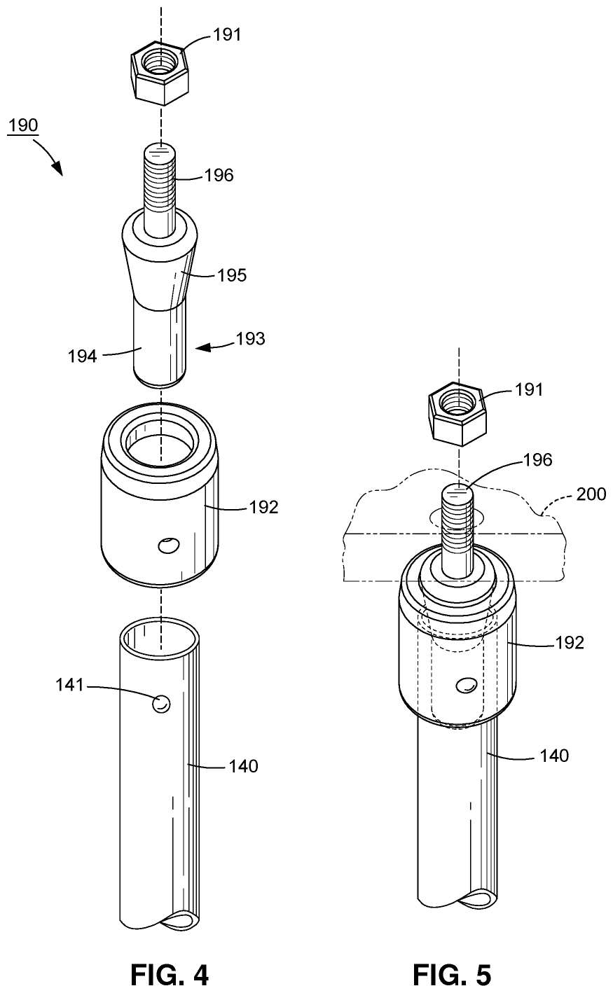

FIGS. 4 and 5 show views of a different interconnect apparatus 190 which is configured to be coupled to a leg 140 of a miter saw stand, in accordance with another non-limiting embodiment of the disclosed concept. As shown, interconnect apparatus 190 includes a nut 191, a base member 192, and a bolt member 193. Bolt member 193 is coupled to nut 191 and has a cylindrical-shaped portion 194, a conical-shaped portion 195 extending therefrom, and a bolt portion 196 extending from conical-shaped portion 195 away from cylindrical-shaped portion 194. In operation, base member 192 is coupled to leg 140 (e.g., preferably via suitable fasteners such as, for example, rivets through rivet hole 141 and a similar hole on base member 192), and cylindrical-shaped portion 194 of bolt member 193 is configured to be received in and coupled to an interior of base member 192. It will be appreciated that conical-shaped portion 195 of bolt member 193 may be engaged with an interior surface or edge of base member 192 in a relatively high pressure manner. Stated differently, bolt member 193 may be engaged with base member 192 in a press-fit manner. Accordingly, because of the nature by which base member 192 cuts into (or engages in an interfering fashion) conical-shaped portion 195 (e.g., the relatively small amount of surface area therebetween), a tight fitting connection can occur between these components. This is similar to the connection between miter saw 100 and body portions 93,94,95, discussed above. Additionally, in one example base member 192, conical-shaped portion 195, and bolt portion 196 are all concentric with leg 140.

As shown in FIG. 5, base member 192 and portions 194,195 (not labeled in FIG. 5) of bolt member 193 are configured to be located on a first side of miter saw 200 (partially shown in phantom line drawing), while bolt portion 196 is configured to extend through a thru hole in the miter saw 200. In one example, a miter saw stand may employ four interconnect apparatus the same as the interconnect apparatus 190, each configured such that a corresponding bolt portion (e.g., bolt portion 196) extends through a mounting hole (e.g., one of four mounting holes of the miter saw).

Furthermore, nut 191 is located on an opposing side of miter saw 200 and is configured to be tightly secured with bolt portion 196, and thus couple miter saw 200 to interconnect apparatus 190. It will similarly be appreciated that other legs of the miter saw stand may be connected to miter saw via interconnect apparatus similar to interconnect apparatus 190, or via a suitable alternative interconnect apparatus within the scope of the disclosed concept, e.g., interconnect apparatus 60,70,80,90.

The size (such as diameter or other cross-sectional dimension, and height) of the legs may vary, such as depending upon the use (such as the desired height of the tool being supported by the stand) and/or the weight of the stand (wherein the diameter of the legs may be increased, for example, to increase the load capacity of the stand). Similarly, the size (length, cross-sectional dimension) of the brace members may be varied.

In one configuration, the base members or feet can be made from a rubber material or co-molded of plastic with a rubber pad to prevent slipping on flat or wet surfaces and to reduce vibration transfer that can be an issue with power tools.

While, as noted above, the base members and interconnect apparatus may be constructed from plastic (which has certain advantages as detailed above), the base members/feet and/or the interconnect apparatus (or portions thereof) can be made of metal (such as by casting or machining), such as when metal cutting tools or in other situations where the stand may be exposed to high heat. In one embodiment, the removable interconnect apparatus permits a user to change between plastic interconnect members and metal members. For example, relative to the embodiment illustrated in FIG. 4, a user might change between a metal and plastic bolt member 193 simply by exchanging them relative to the base member 192.

As detailed above, an aspect of the invention is a stand, such as which is useful in supporting one or more tools. The stand is configured to securely support a tool, such as a miter saw, in a raised position, when the stand is moved to its DEPLOYED position (in the illustrated embodiment, in this configuration, the legs 10,20,30,40 are generally vertically extending and are spaced from one another). It will be appreciated that the distance that the legs 10,20,30,40 are spread apart may be adjusted to permit the interconnect apparatus 90,190 to align with any of the plurality of mounting holes (e.g., the four mounting holes in the example of FIG. 1, and the four mounting holes into which the interconnect apparatus 190 and similarly structured interconnect apparatus extend) or similar features of an associated tool.

Further, the stand may be moved to a COLLAPSED position, such as for storage. In this configuration, the legs 10,20,30,40 are moved towards one another, such as to be adjacent one another. This substantially reduces the dimension of the stand in the length and width (but not height) directions. The stand may then be stored (shipped, etc.) in various orientations.

Additionally, in one example a method of mounting miter saw 100 to miter saw stand 2 includes the steps of providing the miter saw stand 2 with a plurality of spaced apart legs 10,20,30,40 each coupled to one another, each leg of the plurality of legs 10,20,30,40 comprising a first end, a second end located opposite the first end, and an interconnect apparatus 60,70,80,90 coupled to the second end; and extending the interconnect apparatus 60,70,80,90 into a corresponding one of the mounting holes of the miter saw 100 to mount said each leg to the miter saw 100. The legs 10,20,30,40 may each be spaced a distance from one another, and the method may further include moving the plurality of legs between a DEPLOYED position and a COLLAPSED position, such that as the plurality of legs move from the DEPLOYED position toward the COLLAPSED position, the distance decreases.

As indicated, the disclosed concept also provides for an improved (e.g., without limitation, more securely connected) miter saw stand 2 and interconnect apparatus 60,70,80,90,190 therefor in which a miter saw 100,200 is advantageously able to be easily associated with the stand, but also be more securely connected to a miter saw stand 2 during use, thus minimizing the likelihood of injury and misuse.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A miter saw stand structured to be coupled to a miter saw, said miter saw having a plurality of mounting holes, said miter saw stand comprising:
a plurality of spaced apart legs each coupled to one another and together configured to support said miter saw, each leg of said plurality of legs comprising:
a first end,
a second end disposed opposite the first end, and
an interconnect apparatus coupled to said second end and configured to extend into a corresponding one of said mounting holes of said miter saw in order to mount said each leg to said miter saw;
whereby said miter saw is configured to be supported in an elevated position at said second ends of said plurality of legs of said miter saw stand.

2. The miter saw stand according to claim 1, wherein said plurality of legs are each spaced a distance from one another and are configured to move between a DEPLOYED position and a COLLAPSED position, and wherein, as said plurality of legs moves from the DEPLOYED position toward the COLLAPSED position, the distance decreases.

3. The miter saw stand according to claim 2, wherein said interconnect apparatus comprises a base portion and at least one body portion extending from said base portion into said corresponding one of said mounting holes, wherein said base portion is coupled to the second end, and wherein said at least one body portion is configured to engage said miter saw in a press-fit manner.

4. The miter saw stand according to claim 3, wherein said at least one body portion comprises a plurality of triangular-shaped body portions each extending from said base portion into said corresponding one of said mounting holes, and wherein each of said triangular-shaped body portions is configured to engage said miter saw in a press-fit manner.

5. The miter saw stand according to claim 4, wherein said interconnect apparatus further comprises a stud portion disposed opposite said base portion, and wherein each of said triangular-shaped body portions extends from said stud portion to said base portion.

6. The miter saw stand according to claim 4, wherein said plurality of triangular-shaped body portions comprises four triangular-shaped body portions.

7. The miter saw stand according to claim 4, wherein said interconnect apparatus is a unitary component made from a single piece of material.

8. The miter saw stand according to claim 2, wherein said interconnect apparatus comprises a bolt member configured to extend through said corresponding one of said mounting holes.

9. The miter saw stand according to claim 8, wherein said interconnect apparatus further comprises a base member and a nut, wherein said nut is coupled to said bolt member, wherein said base member is coupled to said second end, and wherein said bolt member is engaged with said base member in a press-fit manner.

10. The miter saw stand according to claim 9, wherein said bolt member comprises a cylindrical-shaped portion, a conical-shaped portion extending from said cylindrical-shaped portion, and a bolt portion extending from said conical-shaped portion away from said cylindrical-shaped portion, wherein said conical-shaped portion is engaged with an interior edge of said base member, and wherein said base member, said conical-shaped portion, and said bolt portion are all concentric with said each leg.

11. A method of mounting a miter saw to a miter saw stand, said miter saw having a plurality of mounting holes, the method comprising:
providing said miter saw stand with a plurality of spaced apart legs each coupled to one another, each leg of said plurality of legs comprising a first end, a second end disposed opposite the first end, and an interconnect apparatus coupled to said second end; and
extending said interconnect apparatus into a corresponding one of said mounting holes of said miter saw to mount said each leg to said miter saw.

12. The method according to claim 11, wherein said plurality of legs are each spaced a distance from one another, and wherein the method further comprises moving said plurality of legs between a DEPLOYED position and a COLLAPSED position, such that as said plurality of legs move from the DEPLOYED position toward the COLLAPSED position, the distance decreases.

13. The method according to claim 12, wherein said interconnect apparatus comprises a base portion and at least one body portion extending from said base portion into said corresponding one of said mounting holes, wherein said base portion is coupled to the second end, and wherein said at least one body portion is configured to engage said miter saw in a press-fit manner.

14. The method according to claim 13, wherein said at least one body portion comprises a plurality of triangular-shaped body portions each extending from said base portion into said corresponding one of said mounting holes, and wherein each of said triangular-shaped body portions is configured to engage said miter saw in a press-fit manner.

15. The method according to claim 14, wherein said interconnect apparatus further comprises a stud portion disposed opposite said base portion, and wherein each of said triangular-shaped body portions extends from said stud portion to said base portion.

16. The method according to claim 14, wherein said plurality of triangular-shaped body portions comprises four triangular-shaped body portions.

17. The method according to claim 14, wherein said interconnect apparatus is a unitary component made from a single piece of material.

18. The method according to claim 12, wherein said interconnect apparatus comprises a bolt member configured to extend through said corresponding one of said mounting holes.

19. The method according to claim 18, wherein said interconnect apparatus further comprises a base member and a nut, wherein said nut is coupled to said bolt member, wherein said base member is coupled to said second end, and wherein said bolt member is engaged with said base member in a press-fit manner.

20. The method according to claim 19, wherein said bolt member comprises a cylindrical-shaped portion, a conical-shaped portion extending from said cylindrical-shaped portion, and a bolt portion extending from said conical-shaped portion away from said cylindrical-shaped portion, wherein said conical-shaped portion is engaged with an interior edge of said base member, and wherein said base member, said conical-shaped portion, and said bolt portion are all concentric with said each leg.
